(19) United States
(12) Patent Application Publication
(10) Pub. No.: US 2012/0243162 A1
(43) Pub. Date: Sep. 27, 2012

(54) PORTABLE KEYBOARD

(76) Inventors: Chia-Hung Liu, Taoyuan (TW); Ting-Kuei Cheng, Taoyuan (TW); Chang-En Sun, Taoyuan (TW)

(21) Appl. No.: 13/239,328

(22) Filed: Sep. 21, 2011

(30) Foreign Application Priority Data
Mar. 23, 2011 (TW) 100109854

(51) Int. Cl. G06F 1/16

(52) U.S. Cl. 361/679.15; 361/679.2

(57) ABSTRACT

A portable keyboard includes a base, a holder, a support member, a foldable keyboard and a linking member. One end of the support member is pivotally connected to the base and the other end of the support member is pivotally connected to the holder. The foldable keyboard is disposed on the base and includes a first keyboard module, a second keyboard module and a pivot. The first keyboard module is pivotally connected to the second keyboard module by the pivot, such that the first and second keyboard modules can be folded or expanded with respect to each other over the base. One end of the linking member is connected to the pivot and the other end of the linking member is pivotally connected to the holder, such that the holder and the foldable keyboard can move together with each other.

### BACKGROUND OF THE INVENTION

1. Field of the Invention

The invention relates to a portable keyboard and, more particularly, to a portable keyboard equipped with a foldable keyboard. Especially, a holder equipped with an electronic device can move together with the foldable keyboard.

2. Description of the Prior Art

As technology advances and develops, various electronic devices, such as mobile phone, personal digital assistant, tablet personal computer, electronic paper, and so on, have been used in daily life widely. Since the size of the aforesaid electronic device is usually small, a connecting port is disposed on the electronic device and used for connecting a keyboard for input purpose. If a user wants to use the electronic device for a long time, the user is used to place the electronic device on a support frame, such that an appropriate operation angle is formed between the electronic device and the user. Accordingly, the user can use the external keyboard to operate the electronic device for a long time comfortably. However, in the prior art, since the keyboard and the support frame are independent, the user needs to store the keyboard and the support frame in additional space respectively. Consequently, the keyboard and the support frame are easy to be lost.

### SUMMARY OF THE INVENTION

Therefore, an objective of the invention is to provide a portable keyboard equipped with a foldable keyboard so as to solve the aforesaid problems. Especially, a holder equipped with an electronic device can move together with the foldable keyboard.

According to an embodiment, a portable keyboard of the invention comprises a base, a holder, a support member, a foldable keyboard and a linking member. One end of the support member is pivotally connected to the base and another end of the support member is pivotally connected to the holder. The foldable keyboard is disposed on the base. The foldable keyboard comprises a first keyboard module, a second keyboard module and a pivot. The first keyboard module is pivotally connected to the second keyboard module by the pivot, such that the first keyboard module and the second keyboard module can be folded or expanded with respect to each other over the base. One end of the linking member is connected to the pivot and another end of the linking member is pivotally connected to the holder, such that the holder and the foldable keyboard can move together with each other.

As mentioned in the above, since the first and second keyboard modules of the foldable keyboard are pivotally connected to each other by the pivot, the first and second keyboard modules can rotate with respect to each other over the base so as to be folded or expanded over the base. Furthermore, since one end of the linking member is pivotally connected to the pivot and the other end of the linking member is pivotally connected to the holder, the holder and the foldable keyboard can move together with each other due to the linking member when the holder rotates with respect to the linking member and/or when the first and second keyboard modules rotate with respect to each other over the base.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view illustrating a portable keyboard according to an embodiment of the invention.

FIG. 2 is an exploded view illustrating the portable keyboard shown in FIG. 1.

FIG. 3 is a perspective view illustrating the portable keyboard shown in FIG. 1 from another view angle.

FIG. 4 is an exploded view illustrating the portable keyboard shown in FIG. 3.

FIG. 5 is a perspective view illustrating the portable keyboard shown in FIG. 1 being opened.

FIG. 6 is a perspective view illustrating the portable keyboard shown in FIG. 5 from another view angle.

FIG. 7 is a perspective view illustrating the portable keyboard shown in FIG. 6 from another view angle.

FIG. 8 is a perspective view illustrating the portable keyboard shown in FIG. 1 opened completely.

FIG. 9 is a perspective view illustrating the portable keyboard shown in FIG. 8 from another view angle.

FIG. 10 is a perspective view illustrating the portable keyboard shown in FIG. 8 from another view angle.

FIG. 11 is a perspective view illustrating the inner holder shown in FIG. 9 rotating with respect to the outer holder.

FIG. 12 is a perspective view illustrating the inner holder shown in FIG. 9 after rotating with respect to the outer holder.

FIG. 13 is a perspective view illustrating the portable keyboard shown in FIG. 1 being closed.

FIG. 14 is a perspective view illustrating the portable keyboard shown in FIG. 1 closed completely.

### DETAILED DESCRIPTION

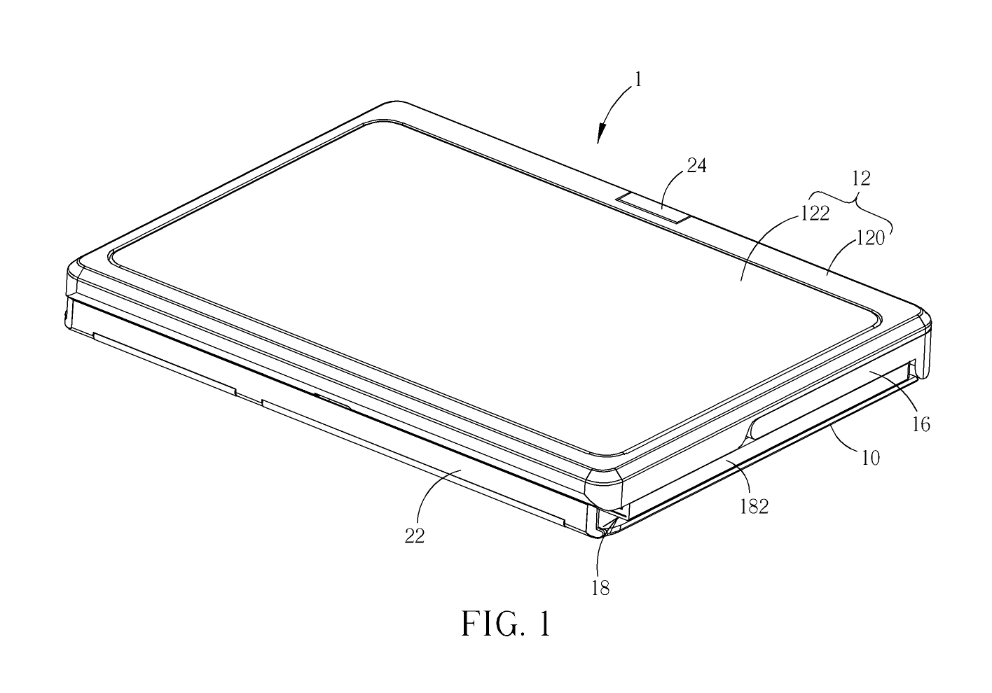

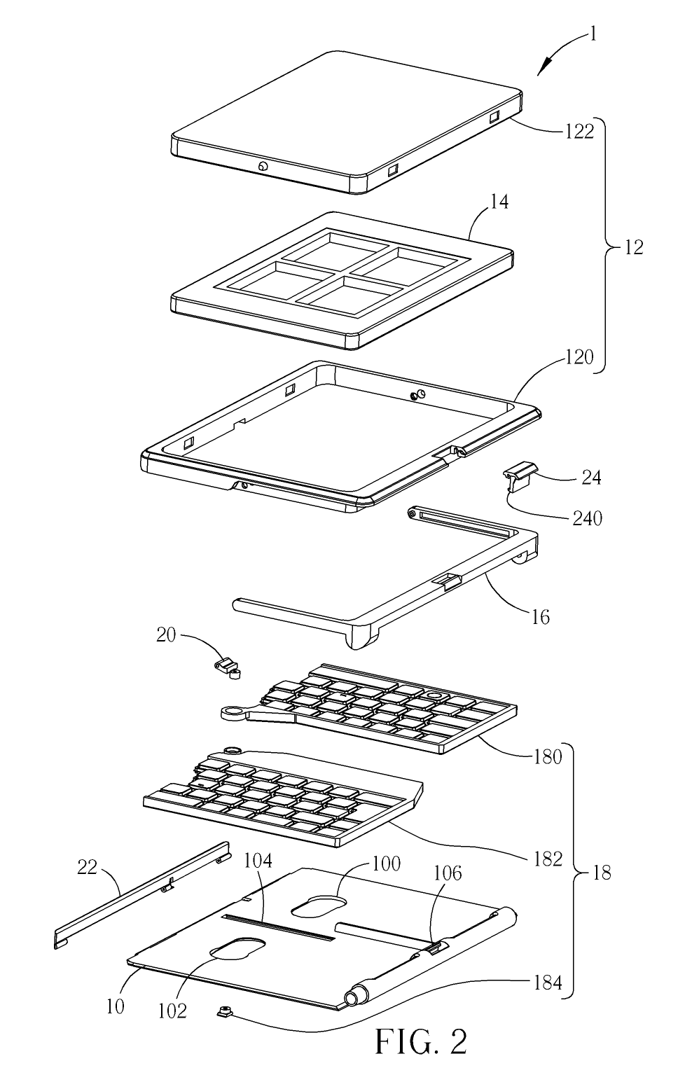

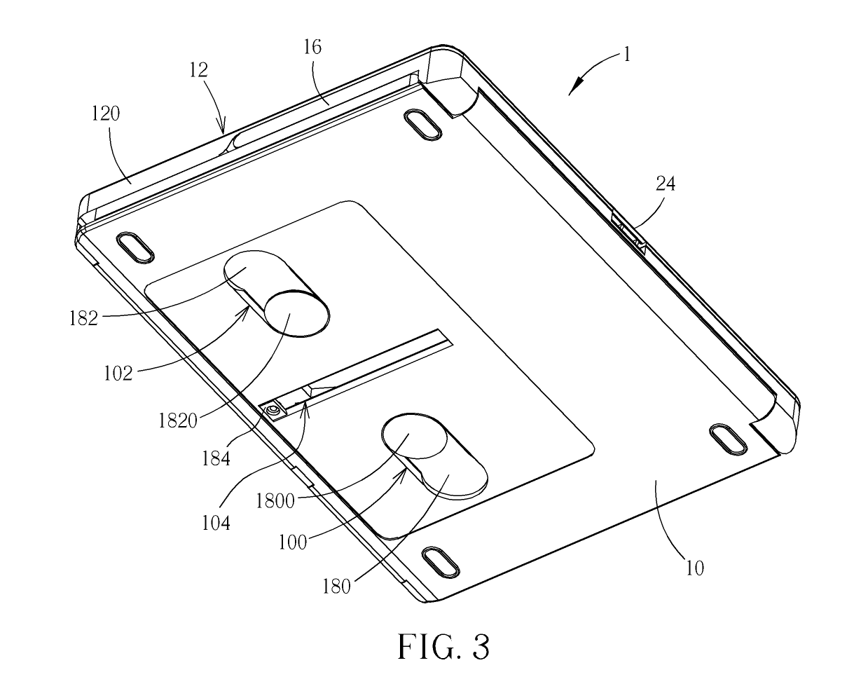

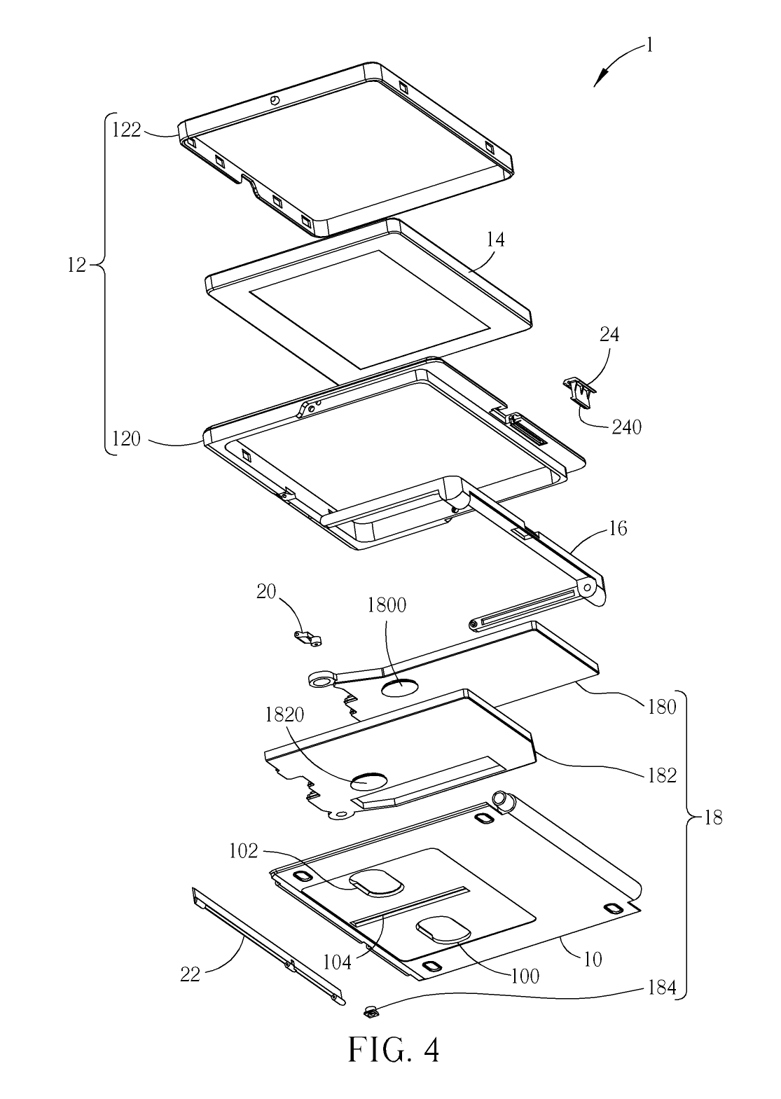

Referring to FIGS. 1 to 4, FIG. 1 is a perspective view illustrating a portable keyboard 1 according to an embodiment of the invention, FIG. 2 is an exploded view illustrating the portable keyboard 1 shown in FIG. 1, FIG. 3 is a perspective view illustrating the portable keyboard 1 shown in FIG. 1 from another view angle, and FIG. 4 is an exploded view illustrating the portable keyboard 1 shown in FIG. 3.

As shown in FIGS. 1 to 4, the portable keyboard 1 comprises a base 10, a holder 12, a support member 16, a foldable keyboard 18, a linking member 20, a lid 22 and a switch 24. In this embodiment, the holder 12 may comprise an outer holder 120 and an inner holder 122. The outer holder 120 is pivotally connected to the linking member 20 and the inner holder 122 is pivotally connected within the outer holder 120. An electronic device 14 can be disposed on the inner holder 122. Preferably, the electronic device 14 may be detachably disposed on the inner holder 122. In practical applications, the electronic device 14 may be a tablet personal computer or other portable electronic devices. One end of the support member 16 is pivotally connected to the base 10 and another end of the support member 16 is pivotally connected to the outer holder 120 of the holder 12, such that the support member 16 can rotate with respect to the base 10 and the holder 12 can rotate with respect to the support member 16.

The foldable keyboard 18 is disposed on the base 10. In this embodiment, the foldable keyboard 18 comprises a first keyboard module 180, a second keyboard module 182 and a pivot 184, wherein the bottom of the first keyboard module 180 may have a first protrusion 1800 and the bottom of the second keyboard module 182 may have a second protrusion 1820. Furthermore, the base 10 may have a first slot 100, a second slot 102 opposite to the first slot 100, and a third slot 104 located between the first slot 100 and the second slot 102, wherein an orientation of the first slot 100 is parallel to an orientation of the second slot 102 and an orientation of the third slot 104 is perpendicular to the orientations of the first slot 100 and the second slot 102.

In this embodiment, the first protrusion 1800 of the first keyboard module 180 is disposed in the first slot 100 of the base 10, the second protrusion 1820 of the second keyboard module 182 is disposed in the second slot 102 of the base 10, the first keyboard module 180 is pivotally connected to the second keyboard module 182 by the pivot 184, and one end of the pivot 184 is movably disposed in the third slot 104 of the base 10. Accordingly, when the first keyboard module 180 and the second keyboard module 182 rotate with respect to each other, the first protrusion 1800 and the second protrusion 1820 can rotate and move within the first slot 100 and the second slot 102 respectively and the pivot 184, which pivotally connects the first keyboard module 180 and the second keyboard module 182, can move within the third slot 104, such that the first keyboard module 180 and the second keyboard module 182 can be folded or expanded with respect to each other over the base 10.

It should be noted that the assembly structures of the foldable keyboard 18 and the base 10 are not limited to the aforesaid embodiment. In other words, the main feature of the invention is that the first keyboard module 180 and the second keyboard module 182 of the foldable keyboard 18 can rotate with respect to each other so as to be folded or expanded over the base 10.

One end of the linking member 20 is connected to the pivot 184 and another end of the linking member 20 is pivotally connected to the outer holder 120 of the holder 12, such that the holder 12 and the foldable keyboard 18 can move together with each other. The lid 22 is pivotally connected to one side of the base 10. Preferably, the lid 22 may be pivotally connected to one side of the base 10 by a torsion spring. When the first keyboard module 180 and the second keyboard module 182 are folded with respect to each other over the base 10, the lid 22 cooperates with the holder 12 to cover the foldable keyboard 18 (as shown in FIG. 1). The switch 24 may be rotatably disposed on one side of the outer holder 120 of the holder 12. In this embodiment, the switch 24 may have a first engaging portion 240 and the base 10 may have a second engaging portion 106 corresponding to the first engaging portion 240. When the first keyboard module 180 and the second keyboard module 182 are folded with respect to each other over the base 10 and the holder 12 rotates with respect to the pivot 184 so as to cover the foldable keyboard 18, the first engaging portion 240 of the switch 24 is engaged with the second engaging portion 106 of the base 10 so as to prevent the holder from being opened due to mis-operation.

It should be noted that the holder 12 may be detachably fixed on the base 10 by other manners. For example, two magnets may be disposed on the holder 12 and the base 10 respectively, so that the holder 12 may be detachably fixed on the base 10 by magnetic force. In other words, the aforesaid structure design regarding the switch 24 is one embodiment of the invention and the invention is not limited to this embodiment.

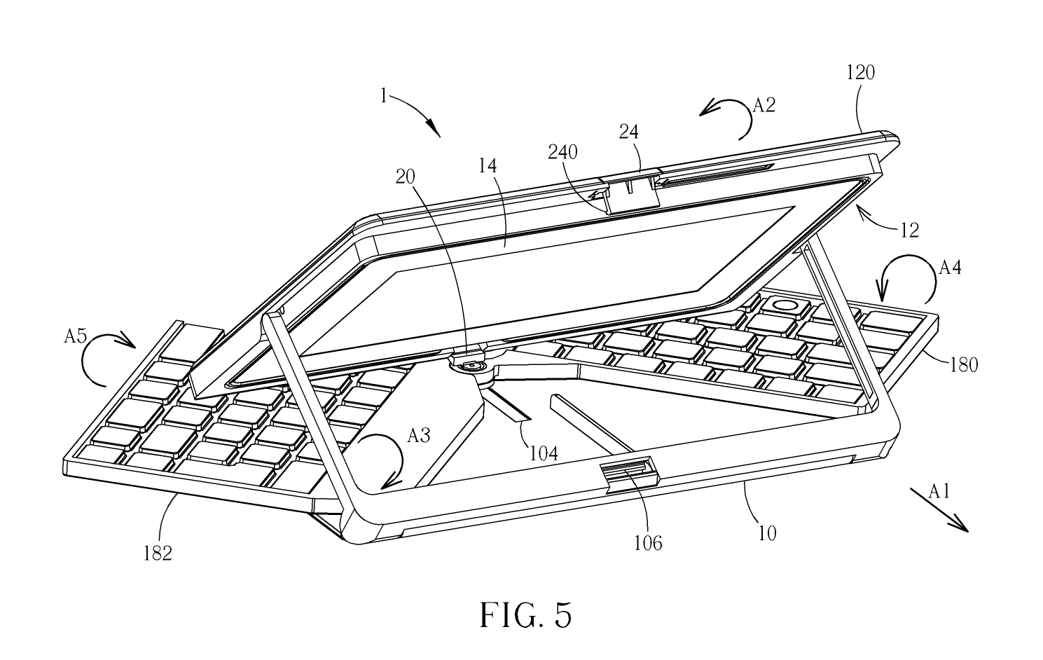

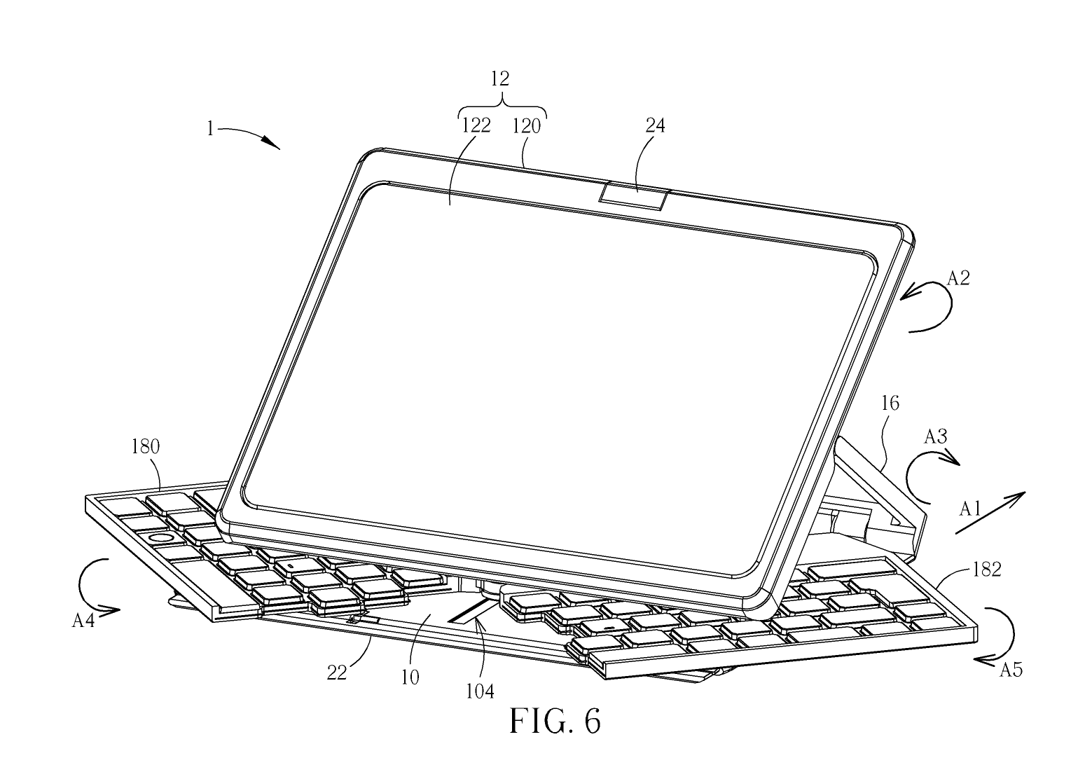

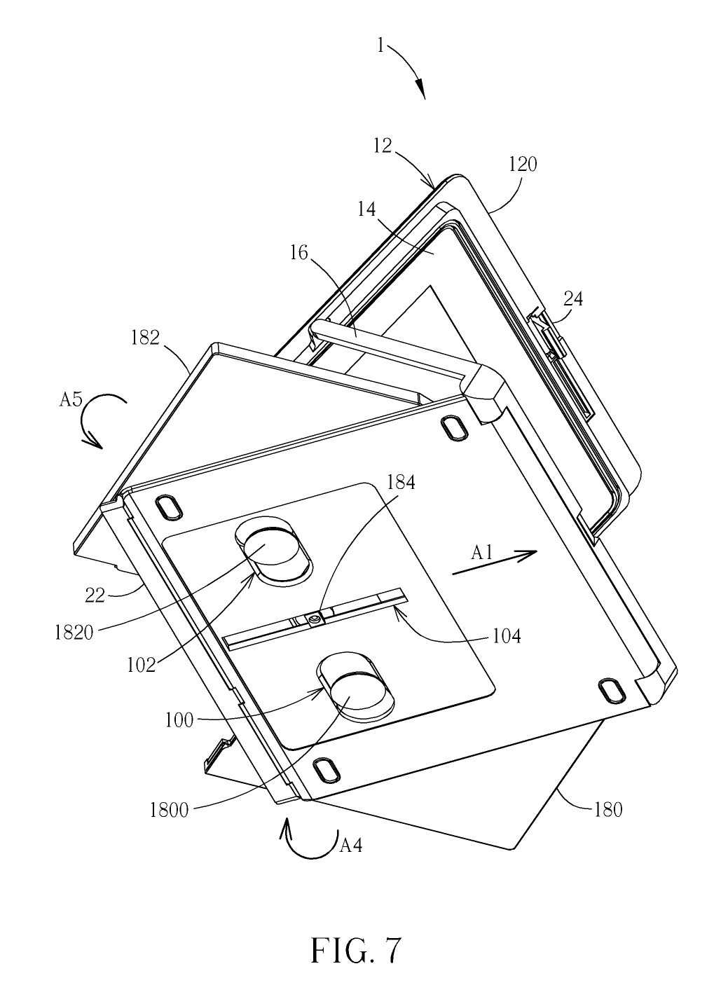

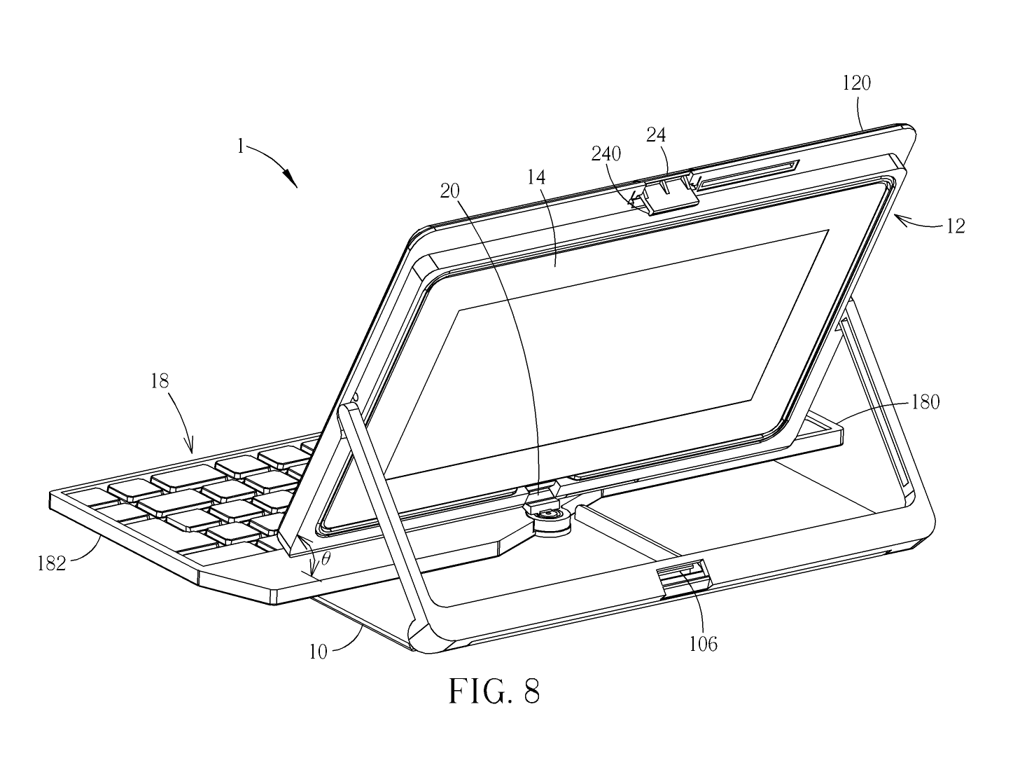

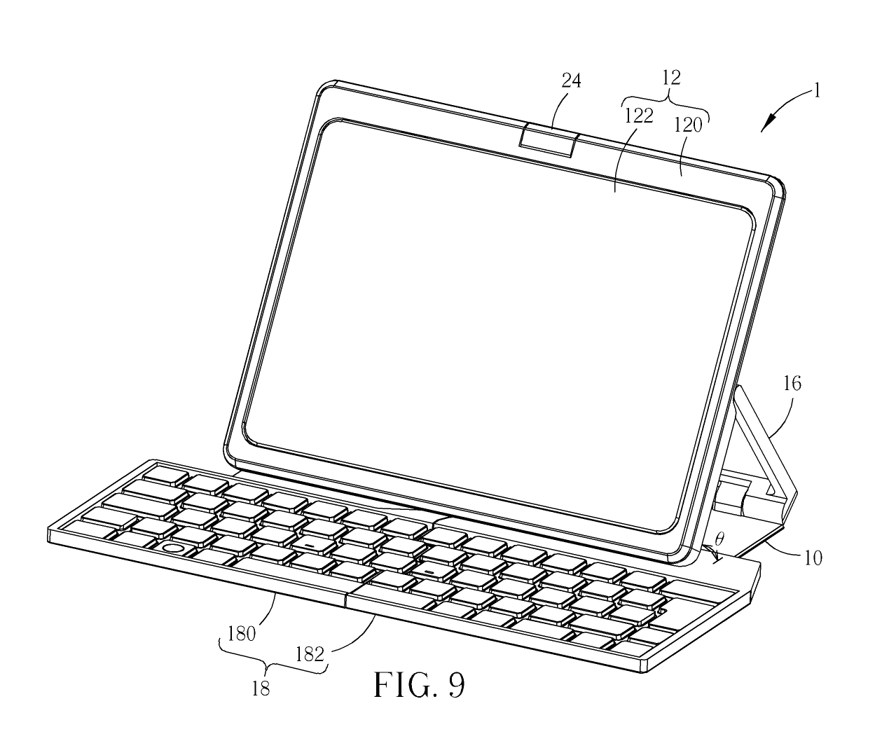

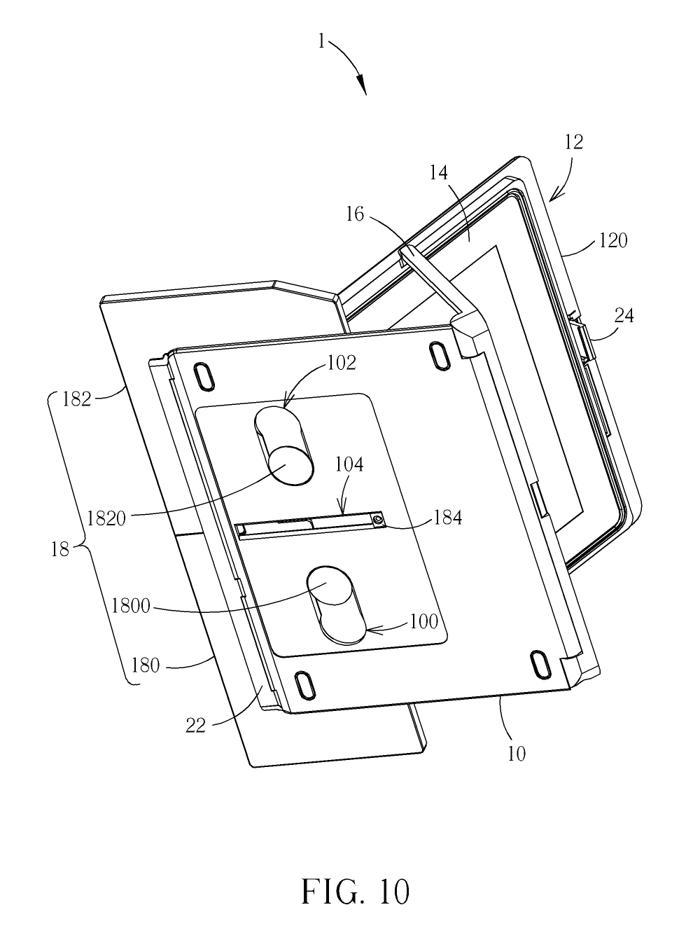

Referring to FIGS. 5 to 10, FIG. 5 is a perspective view illustrating the portable keyboard 1 shown in FIG. 1 being opened, FIG. 6 is a perspective view illustrating the portable keyboard 1 shown in FIG. 5 from another view angle, FIG. 7 is a perspective view illustrating the portable keyboard 1 shown in FIG. 6 from another view angle, FIG. 8 is a perspective view illustrating the portable keyboard 1 shown in FIG. 1 opened completely, FIG. 9 is a perspective view illustrating the portable keyboard 1 shown in FIG. 8 from another view angle, and FIG. 10 is a perspective view illustrating the portable keyboard 1 shown in FIG. 8 from another view angle.

When a user wants to use the portable keyboard 1 to operate the electronic device 14, the user has to open the switch 24 so as to release the engagement between the holder 12 and the base 10. Afterward, as shown in FIGS. 5 to 7, the user can push the holder 12 toward the direction indicated by the arrow A1. At this time, the holder 12 rotates with respect to the support member 16 and the linking member 20 toward the direction indicated by the arrow A2, and the support member 16 is driven by the holder 12 to rotate with respect to the base 10 toward the direction indicated by the arrow A3. When the holder 12 is moving toward the direction indicated by the arrow A1 and rotating toward the direction indicated by the arrow A2, the holder 12 is also driving the linking member 20 and the pivot 184 to move along the third slot 104 toward the direction indicated by the arrow A1 so as to drive the first keyboard module 180 and the second keyboard module 182 to rotate toward the directions indicated by the arrows A4 and A5 respectively. Moreover, the lid 22 will be pushed by the first keyboard module 180 and the second keyboard module 182 to rotate outwardly.

Finally, the first keyboard module 180 and the second keyboard module 182 can rotate with respect to each other so as to be expanded over the base 10 completely, as shown in FIGS. 8 to 10. When the first keyboard module 180 and the second keyboard module 182 are expanded with respect to each other over the base 10, the holder 12 rotates with respect to the linking member 20 such that an angle θ is formed between the holder 12 and the foldable keyboard 18.

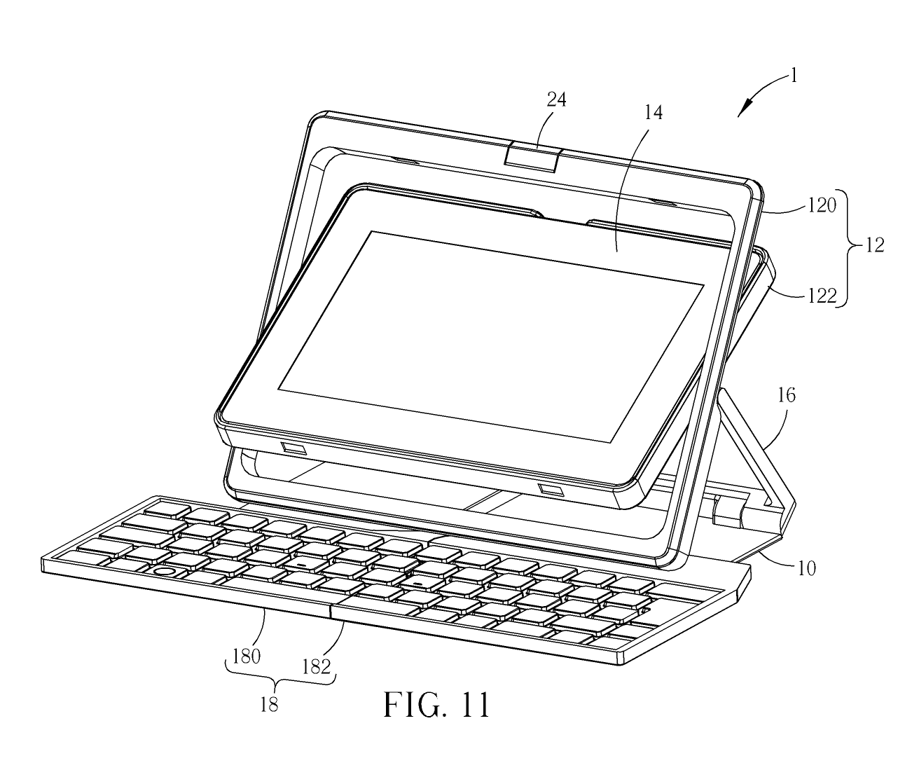

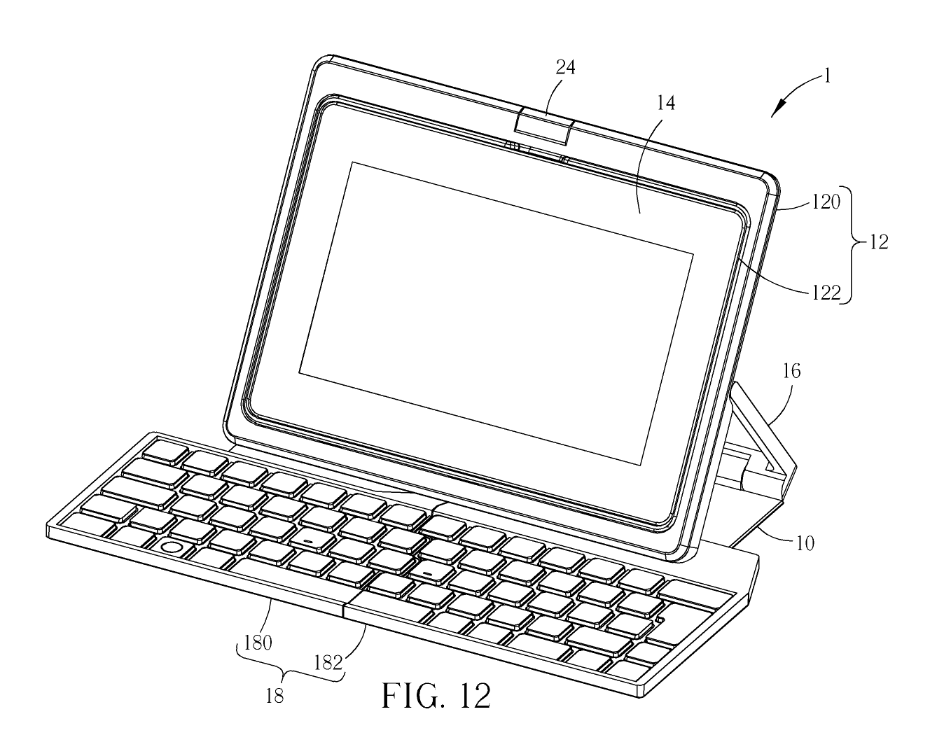

Referring to FIGS. 11 and 12, FIG. 11 is a perspective view illustrating the inner holder 122 shown in FIG. 9 rotating with respect to the outer holder 120, and FIG. 12 is a perspective view illustrating the inner holder 122 shown in FIG. 9 after rotating with respect to the outer holder 120. After the portable keyboard 1 is opened completely (as shown in FIG. 9), the user can rotate the inner holder 122 with respect to the outer holder 120 (as shown in FIG. 11) so as to make the electronic device 14 disposed on the inner holder 122 face the user (as shown in FIG. 12). At this time, the user can use the foldable keyboard 18 to operate the electronic device 14 disposed on the inner holder 122. When the user finishes using the portable keyboard 1 to operate the electronic device 14, the user can rotate the inner holder 122 with respect to the outer holder 120 to be the state shown in FIG. 9. Afterward, the user can push the holder 12 toward the reverse direction of the arrow A1 shown in FIG. 6 so as to drive the first keyboard module 180 and the second keyboard module 182 to rotate with respect to each other. Consequently, the first keyboard module 180 and the second keyboard module 182 are folded with respect to each other over the base 10, as shown in FIG. 1. At this time, the electronic device 14 is hidden in the holder 12 so as to prevent the electronic device 14 from being scratched or damaged. In this embodiment, the electronic device 14 may communicate with the first keyboard module 180 and the second keyboard module 182 of the foldable keyboard 18 in wireless (e.g. wireless transmitting technology including Bluetooth, WiFi, infra red, etc.).

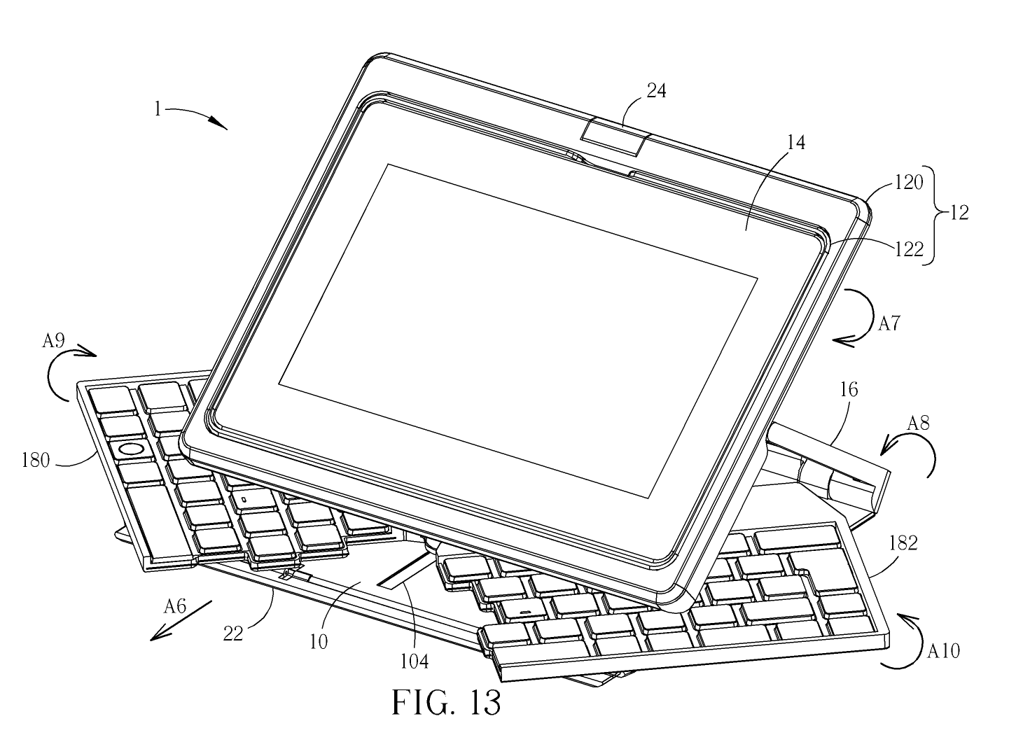

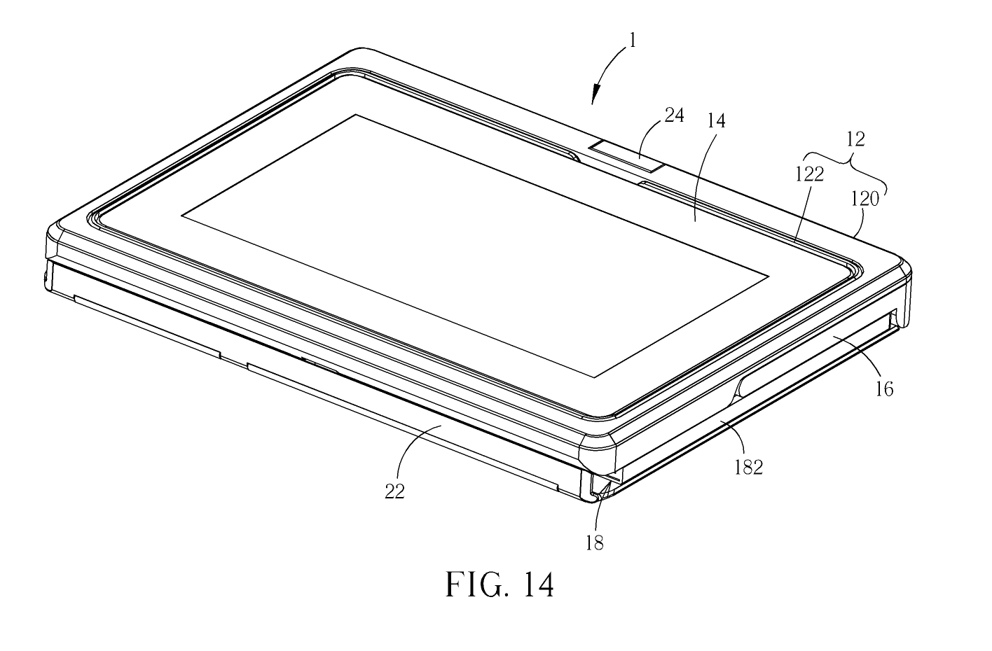

Referring to FIGS. 13 and 14, FIG. 13 is a perspective view illustrating the portable keyboard 1 shown in FIG. 1 being closed, and FIG. 14 is a perspective view illustrating the portable keyboard 1 shown in FIG. 1 closed completely. As shown in FIG. 13, the user can push the holder 12 toward the direction indicated by the arrow A6. When the holder 12 is moving toward the direction indicated by the arrow A6, the holder 12 is also rotating toward the direction indicated by the arrow A7 and the support member 16 is rotating toward the direction indicated by the arrow A8, so as to drive the first keyboard module 180 and the second keyboard module 182 to rotate toward the directions indicated by the arrows A9 and A10 respectively. Finally, the first keyboard module 180 and the second keyboard module 182 can rotate with respect to each other so as to be folded over the base 10 completely. When the first keyboard module 180 and the second keyboard module 182 are folded with respect to each other over the base 10, the foldable keyboard 18 is completely located within an area of the base, the holder 12 rotates with respect to the linking member 20 so as to cover the foldable keyboard 18, and the lid 22 rotates upwardly so as to cooperate with the holder 12 to cover the foldable keyboard 18, as shown in FIG. 14. At this time, the user can operates the electronic device 14 directly since the electronic device 14 is exposed out of the holder 12.

When the user finishes using the electronic device 14, the user can push the holder 12 toward the reverse direction of the arrow A6 shown in FIG. 13 so as to drive the first keyboard module 180 and the second keyboard module 182 to rotate with respect to each other. Accordingly, the first keyboard module 180 and the second keyboard module 182 are expanded with respect to each other over the base 10, as shown in FIG. 12. Afterward, the user can rotate the inner holder 122 with respect to the outer holder 120 to be the state shown in FIG. 9. Afterward, the user can push the holder 12 toward the reverse direction of the arrow A1 shown in FIG. 6 so as to drive the first keyboard module 180 and the second keyboard module 182 to rotate with respect to each other. Consequently, the first keyboard module 180 and the second keyboard module 182 are folded with respect to each other over the base 10, as shown in FIG. 1. At this time, the electronic device 14 is hidden in the holder 12 so as to prevent the electronic device 14 from being scratched or damaged.

As mentioned in the above, since the first and second keyboard modules of the foldable keyboard are pivotally connected to each other by the pivot, the first and second keyboard modules can rotate with respect to each other over the base so as to be folded or expanded over the base. Furthermore, since one end of the linking member is pivotally connected to the pivot and the other end of the linking member is pivotally connected to the holder, the holder and the foldable keyboard can move together with each other due to the linking member when the holder rotates with respect to the linking member and/or when the first and second keyboard modules rotate with respect to each other over the base.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A portable keyboard comprising:
a base;
a holder;
a support member, One end of the support member being pivotally connected to the base and another end of the support member being pivotally connected to the holder;
a foldable keyboard disposed on the base, the foldable keyboard comprising a first keyboard module, a second keyboard module and a pivot, the first keyboard module being pivotally connected to the second keyboard module by the pivot, such that the first and second keyboard modules are capable of being folded or expanded with respect to each other over the base; and
a linking member, one end of the linking member being connected to the pivot and another end of the linking member being pivotally connected to the holder, such that the holder and the foldable keyboard are capable of moving together with each other.

2. The portable keyboard of claim 1, wherein the holder comprises an outer holder and an inner holder, the outer holder is pivotally connected to the linking member, the inner holder is pivotally connected within the outer holder.

3. The portable keyboard of claim 1, wherein when the first and second keyboard modules are folded with respect to each other over the base, the foldable keyboard is completely located within an area of the base and the holder rotates with respect to the linking member so as to cover the foldable keyboard.

4. The portable keyboard of claim 1, wherein when the first and second keyboard modules are expanded with respect to each other over the base, the holder rotates with respect to the linking member such that an angle is formed between the holder and the foldable keyboard.

5. The portable keyboard of claim 1, further comprising a lid pivotally connected to one side of the base, wherein when the first and second keyboard modules are folded with respect to each other over the base, the lid cooperates with the holder to cover the foldable keyboard.

6. The portable keyboard of claim 1, wherein the base has a first slot and a second slot opposite to the first slot, the first keyboard module has a first protrusion disposed in the first slot, the second keyboard module has a second protrusion disposed in the second slot, when the first and second keyboard modules rotate with respect to each other, the first and second protrusions rotates and moves within the first and second slots respectively such that the first and second keyboard modules are folded or expanded with respect to each other over the base.

7. The portable keyboard of claim 6, wherein the base further has a third slot located between the first and second slots and one end of the pivot is movably disposed in the third slot.

8. The portable keyboard of claim 7, wherein an orientation of the first slot is parallel to an orientation of the second slot, and an orientation of the third slot is perpendicular to the orientations of the first and second slots.

9. The portable keyboard of claim 1, further comprising a switch disposed on one side of the holder, the switch having a first engaging portion, the base having a second engaging portion corresponding to the first engaging portion, wherein when the first and second keyboard modules are folded with respect to each other over the base and the holder rotates with respect to the pivot so as to cover the foldable keyboard, the first engaging portion is engaged with the second engaging portion.

10. The portable keyboard of claim 1, wherein an electronic device is disposed on the holder and the electronic device is a tablet personal computer.

11. The portable keyboard of claim 10, wherein the electronic device communicates with the foldable keyboard in wireless.
